(19) United States
(12) Patent Application Publication
(10) Pub. No.: US 2007/0134132 A1
(43) Pub. Date: Jun. 14, 2007

(54) Plating-thickness monitor apparatus and plating-stopping apparatus

(75) Inventors: Takeharu Tani, Kanagawa-ken (JP); Masayuki Naya, Kanagawa-ken (JP); Yuichi Tomaru, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/635,662

(22) Filed: Dec. 8, 2006

(30) Foreign Application Priority Data
Dec. 8, 2005 (JP) 354276/2005

(51) Int. Cl. G01N 21/00

(52) U.S. Cl. 422/82.05

(57) ABSTRACT

In a plating-thickness monitor apparatus, a base light irradiation unit irradiates a member to be plated with base light L. A detection unit detects the characteristic of reflection light Le emitted from the member to be plated by irradiation with the base light L. A plating-thickness monitor unit examines, based on a detection result obtained by the detection unit, the thickness of a plating material deposited in very small pores formed on the member to be plated during plating.

### BACKGROUND OF THE INVENTION

1. Field of the Invention

The present invention relates to a plating-thickness monitor apparatus and a plating-stopping apparatus. Particularly, the present invention relates to a plating-thickness monitor apparatus for judging the thickness of a plating material to be deposited in very small pores (minute pores) and a plating-stopping apparatus.

2. Description of the Related Art

Conventionally, it is well known that when an anodized coating (anodized alumina layer) is formed on an aluminum material by anodizing the aluminum material (so-called Alumite processing), a multiplicity of very small pores extending in the thickness direction of the anodized coating is formed. The diameters of the very small pores are within the range of approximately 50 nm to 200 nm. Further, a technique for coloring an aluminum material by plating the very small pores is well known. In the method, a metal is deposited in the very small pores to color the aluminum material. Specifically, the color of the aluminum material can be changed to bronze or brown by controlling the thickness of the plating material deposited in the very small pores. This technique is used, for example, to color building materials made of an aluminum material (please refer to European Patent Publication Application No. 0 936 288, “Fun Chemistry Laboratory (52)—Coloring of Anodized Alumina in Rainbow Color”, H. Masuda, Chemistry Today, Tokyo Kagaku Dojin Co., Ltd., pp. 51-54, January 1997, “Theories of Anodized Aluminum 100 Q & A-54. Why Can Alumite Be Colored by Electrolytic Precipitation of Metal in Alumite Pores”, T. Sato and K. Kaminaga, Chapter 5, Paragraph 54, Kallos Publishing Co., Ltd., and “Brilliant Optical Properties of Nanometric Noble Metal Spheres, Rods, and Aperture Arrays”, Appl. Spectroscopy, Vol. 56, No. 5, pp. 124A-135A, 2002).

However, when the aluminum material is colored, as described above, a sufficient reproduction characteristic is not obtained simply by managing temperature, time and the like during plating. When the aluminum material is used at a position where color-matching is required, an appropriate aluminum material selected from a multiplicity of aluminum materials is used. Therefore, there is a need to accurately regulate the thickness of plating deposited in the very small pores so that the thickness becomes a predetermined thickness, thereby enabling easier color-matching of the aluminum material.

Such a need is common to members to be plated that are colored by depositing metal in very small pores formed thereon by anodization.

### SUMMARY OF THE INVENTION

In view of the foregoing circumstances, it is an object of the present invention to provide a plating-thickness monitor apparatus that can more accurately judge the thickness of a plating material to be deposited in very small pores formed by anodization, photolithography or nanoimprinting. It is also an object of the present invention to provide a plating-stopping apparatus.

A first plating-thickness monitor apparatus of the present invention is a plating-thickness monitor apparatus for examining the thickness of a plating material to be deposited in very small pores formed on a member to be plated when the very small pores are plated with a metal, the apparatus comprising:

a base light irradiation means for irradiating the member to be plated with base light during plating;

a detection means for detecting the characteristic of light reflected from the member to be plated by irradiation with the base light; and

a plating-thickness monitor means for examining, based on a detection result obtained by the detection means, the thickness of the plating material deposited in the very small pores. In the plating-thickness monitor apparatus, the base light may be white light, and the characteristic of the reflected light may be a change in the spectrum of the light reflected from the member to be plated. Alternatively, the base light may be monochromatic light, and the characteristic of the reflected light may be a change in the intensity of the light reflected from the member to be plated. Further, when the base light is monochromatic light and the characteristic of the reflected light is a change in the intensity of the light reflected from the member to be plated, the characteristic of the reflected light may indicate a change in the spectrum of light that will be reflected from the member to be plated by irradiation with base light if the base light is white light.

A second plating-thickness monitor apparatus according to the present invention is a plating-thickness monitor apparatus for judging the thickness of a plating material to be deposited in very small pores formed on a member to be plated when the very small pores are plated with a metal, the apparatus comprising:

a base light irradiation means for irradiating a reference member similar to the member to be plated with base light during plating;

a detection means for detecting the characteristic of light reflected from the reference member by irradiation with the base light; and

a plating-thickness monitor means for examining, based on a detection result obtained by the detection means, the thickness of the plating material deposited in the very small pores. In the second plating-thickness monitor apparatus, the base light may be white light, and the characteristic of the reflected light may be a change in the spectrum of the light reflected from the reference member. Alternatively, the base light may be monochromatic light, and the characteristic of the reflected light may be a change in the intensity of light emitted from the reference member. Further, when the base light is monochromatic light and the characteristic of the reflected light is a change in the intensity of the light reflected from the reference member, the characteristic of the reflected light may indicate a change in the spectrum of light that will be reflected from the member to be plated by irradiation with base light if the base light is white light.

The very small pores may be pores formed on a surface layer deposited on the surface of a substrate (base material) forming the member to be plated. Further, the characteristic of the reflected light maybe a phase difference caused by interference between light reflected from the surface of a plating material deposited in the very small pores by irradiation with base light and light reflected from the surface of the substrate by irradiation with the base light transmitted through the surface layer. The member to be plated includes the substrate and the surface layer. The base light may be either white light or monochromatic light.

The very small pores may be formed by anodizing the member to be plated.

The reflected light refers to light emitted (reflected) from the member to be plated by irradiation with base light. For example, the reflected light includes metal fluorescence emitted from the member to be plated by irradiation with the base light.

The plating-stopping apparatus of the present invention is a plating-stopping apparatus for the plating-thickness monitor apparatus. The plating-stopping apparatus is characterized by stopping plating when a signal indicating that the thickness of the plating material deposited in the very small pores has been judged to be the same as a predetermined thickness is detected.

The first plating-thickness monitor apparatus of the present invention is a plating-thickness monitor apparatus comprising:

a base light irradiation means for irradiating a member to be plated with base light while very small pores are plated with a plating metal;

a detection means for detecting the characteristic of light reflected from the member to be plated by irradiation with the base light; and

a plating-thickness monitor means for examining, based on a detection result obtained by the detection means, the thickness of the plating material deposited in the very small pores. Therefore, compared with a conventional method for judging the thickness of plating to be deposited in very small pores by managing temperature and time during plating, it is possible to more accurately judge the thickness of plating. Hence, it is possible to omit color-matching of the member to be plated in the present invention.

If the base light is white light and the characteristic of the reflected light is a change in the spectrum of light reflected from the member to be plated, it is possible to achieve the aforementioned advantageous effects even if the thickness of the deposited plating material is a few hundred nm. Alternatively, if the base light is monochromatic light and the characteristic of reflected light is a change in the intensity of light reflected from the member to be plated, it is possible to achieve effects similar to the aforementioned advantageous effects without failure.

Further, when the base light is monochromatic light and the characteristic of the reflected light is a change in the intensity of light reflected from the member to be plated, the characteristic of the reflected light may indicate a change in the spectrum of light that will be reflected from the member to be plated by irradiation with base light if the base light is white light. If the characteristic of the reflected light indicates a change in the spectrum of the reflected light in such a manner, it is possible to achieve the aforementioned advantageous effects without failure.

The second plating-thickness monitor apparatus of the present invention is a plating-thickness monitor apparatus comprising:

a base light irradiation means for irradiating a reference member similar to the member to be plated with base light during plating;

a detection means for detecting the characteristic of light reflected from the reference member by irradiation with the base light; and

a plating-thickness monitor means for examining, based on a detection result obtained by the detection means, the thickness of a plating material deposited in the very small pores. Therefore, compared with a conventional method for judging the thickness of plating to be deposited in very small pores by managing temperature and time during plating, it is possible to more accurately judge the thickness of plating. Hence, it is possible to omit color-matching of the member to be plated in the present invention.

If the base light is white light and the characteristic of the reflected light is a change in the spectrum of light reflected from the reference member, it is possible to achieve the aforementioned advantageous effects even if the thickness of the deposited plating material is a few hundred nm. Alternatively, if the base light is monochromatic light and the characteristic of the reflected light is a change in the intensity of light reflected from the reference member, it is possible to achieve effects similar to the aforementioned advantageous effects without failure.

Further, when the base light is monochromatic light and the characteristic of the reflected light is a change in the intensity of the light reflected from the reference member, the characteristic of the reflected light may indicate a change in the spectrum of light that will be reflected from the member to be plated by irradiation with base light if the base light is white light. If the characteristic of the reflected light indicates a change in the spectrum of the reflected light in such a manner, it is possible to achieve the aforementioned advantageous effects without failure.

Further, if the very small pores are formed on a surface layer deposited on the surface of a substrate forming the member to be plated, and if the characteristic of the reflected light is a phase difference caused by interference between light reflected from the surface of the plating material deposited in the very small pores by irradiation with the base light and light reflected from the surface of the substrate by irradiation with the base light transmitted through the surface layer, it is possible to achieve the aforementioned advantageous effects without failure.

If the very small pores are formed by anodizing the member to be plated, it is possible to more easily form the very small pores. A plating-stopping apparatus for the plating-thickness monitor apparatus is a plating-stopping apparatus, wherein plating is stopped when a signal indicating that the thickness of the plating material deposited in the very small pores has been judged to be the same as a predetermined thickness is detected. Therefore, it is possible to accurately regulate the thickness of plating to be deposited in the very small pores.

### BRIEF DESCRIPTION OF THE DRAWINGS

FIG. 1 is a schematic diagram illustrating the structure of a plating apparatus including a plating-thickness monitor apparatus and a plating-stopping apparatus according to an embodiment of the present invention;

FIG. 2 is an enlarged sectional view of a member to be plated placed in the plating-thickness monitor apparatus;

FIG. 3 is a diagram illustrating spectra obtained by separating plasm on scattered light;

FIG. 4 is a diagram illustrating spectra obtained by separating metal fluorescence;

FIG. 5 is a diagram illustrating absorption spectra of interference light of two kinds of reflected white light, reflected from the member to be plated;

FIG. 6 is a diagram illustrating detection of an interference state of light reflected from the member to be plated;

FIG. 7 is a diagram illustrating a mode in which a base light irradiation unit and a detection unit are arranged in a plating solution;

FIG. 8 is a diagram illustrating a mode in which irradiation with base light and detection of light emitted from the member to be plated are performed through optical fibers; and

FIG. 9 is a diagram illustrating a mode in which the characteristic of reflected light is detected using a reference member similar to the member to be plated.

### DESCRIPTION OF THE PREFERRED EMBODIMENTS

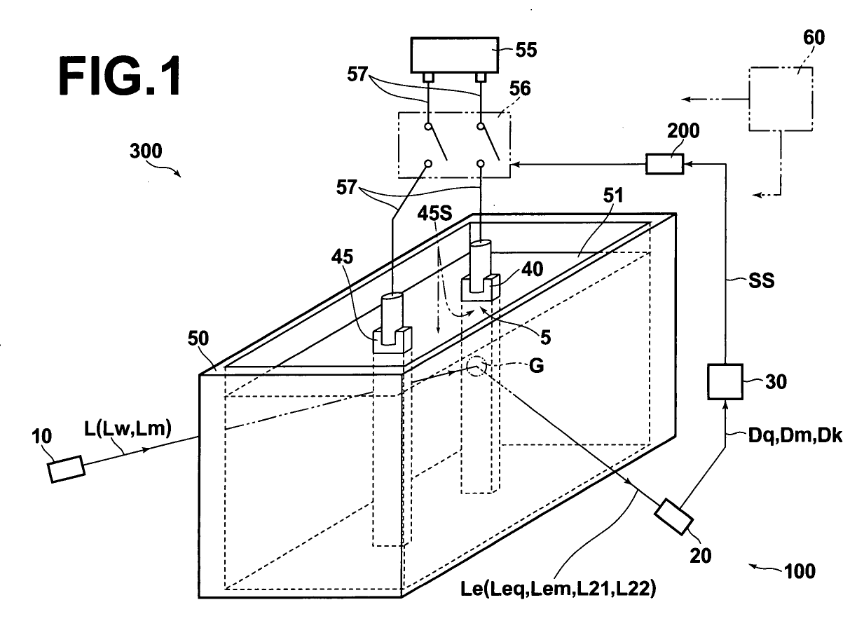

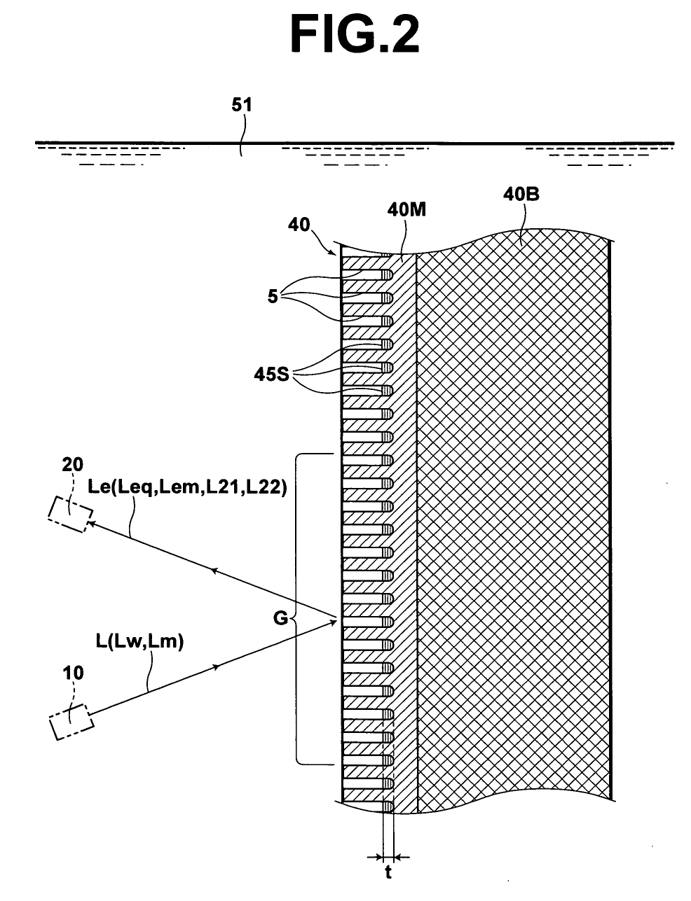

Hereinafter, embodiments of the present invention will be described with reference to the attached drawings. FIG. 1 is a schematic diagram illustrating the structure of a plating apparatus including a plating-thickness monitor apparatus and a plating-stopping apparatus according to an embodiment of the present invention. FIG. 2 is an enlarged sectional view of a member to be plated placed in the plating-thickness monitor apparatus.

A plating apparatus 300 according to an embodiment of the present invention includes a plating-thickness monitor apparatus 100 and a plating-stopping apparatus 200, as illustrated in FIG. 1.

A plating material 45S is ionized and dissolved in a plating solution (plating liquid) 51. The plating material 45S includes a metal that will be deposited in very small holes (hereinafter, also referred to as pores 5) formed on a member 40 to be plated, which will be colored by plating the pores 5 with the metal. The pores 5 are formed by anodization. The polarity of the member 40 to be plated and that of an electrode member 45 are opposite to each other. The plating-thickness monitor apparatus 100 judges the thickness of plating filled in the pores 5. The plating-thickness monitor apparatus 100 includes a base light irradiation unit 10, a detection unit 20 and a judgment unit 30. The base light irradiation unit 10 irradiates a portion G of the member 40 to be plated with base light L. The detection unit 20 detects the characteristic of light Le reflected from the member 40 to be plated by irradiation with the base light L. The judgment unit 30 is a plating-thickness monitor means for judging, based on a detection result by the detection unit 20, whether the thickness t of the plating material deposited in the pores 5 has become the same as a predetermined thickness.

The member 40 to be plated is a member produced by anodizing the surface of an aluminum-based material (by performing so-called Alumite processing). An anodized coating 40M, which is a surface layer formed by anodizing a base material 40B, is provided on the base material 40B, which is a substrate made of an aluminum-based material.

The plating-stopping apparatus 200 is used for the operation of the plating-thickness monitor apparatus 100. The plating-stopping apparatus 200 stops plating when a coincidence judgment signal output from the plating-thickness monitor apparatus 100 is detected. The coincidence judgment signal is a signal indicating that the thickness of the plating material deposited in the pores 5 has become the same as a predetermined thickness.

The plating apparatus 300 includes an electrode member 45, a plating container 50 for keeping a plating solution 51, a direct-current power source 55 and a controller 60 for controlling the whole apparatus. The polarity of the electrode member 45 is opposite to that of the member 40 to be plated. As a material for the electrode member 45, carbon, platinum or the like may be adopted.

The plating container 50 is filled with the plating solution 51, in which the ionized plating material 45S is dissolved. Further, the member 40 to be plated and the electrode member 45 are soaked in the plating solution 51. The member 40 to be plated and the electrode member 45 are connected to a positive pole (anode) and a negative pole (cathode) of the direct-current power source 55 respectively through a switch 56 and cables 57.

When the switch 56 is turned on, the member 40 to be plated and the electrode member 45 are connected to the positive pole and the negative pole of the direct-current power source 55 respectively, and plating is started. When the switch 56 is turned off, the connection is disconnected, and plating is stopped.

The plating-stopping apparatus 200 stops plating by turning off the switch 56 when a coincidence judgment signal output from the judgment unit 30 is detected.

The base light irradiation unit 10 includes a laser diode, which emits monochromatic light with a specific wavelength as base light L. Alternatively, the base light irradiation unit 10 includes a halogen lamp, which emits white light as base light L. The base light irradiation unit 10 irradiates a portion G of the member 40 to be plated with the monochromatic light or the white light.

The detection unit 20 detects the characteristic of light Le reflected from the member 40 to be plated by irradiation with the base light L. Then, the detection unit 20 outputs characteristic data representing the characteristic of the reflected light as a detection result.

Meanwhile, reference data, which is used as a basis for judgment of the thickness of plating, is stored in advance in the judgment unit 30. The judgment unit 30 compares the characteristic data input from the detection unit 20 with the reference data and judges whether the thickness t of the plating material 45S deposited in the pores 5 has become the same as a predetermined thickness tα.

Here, data representing the characteristic of reflected light detected by the detection unit 20 when the thickness reaches the predetermined thickness tα is obtained in advance by an experiment or the like. Data obtained by the experiment is adopted as reference data, which is used as a basis for judging the thickness of plating.

Next, the action of the aforementioned embodiment will be described.

The switch 56 is turned on and plating of the member 40 to be plated is started. Then, the base light irradiation unit 10 irradiates the portion G of the member 40 to be plated, which is placed in the plating solution 51, from the outside of the container 50.

The plating material 45S is not deposited in the pores 5 before plating is started. When the switch 56 is turned on and plating is started, the plating material 45S begins to be deposited in the pores 5. As time passes, the plating material 45S is accumulated on the bottoms of the pores 5, and the thickness t of the plating material 45S deposited in the pores 5 increases.

The detection unit 20 continuously detects the characteristic of reflected light emitted from the member 40 to be plated, which has been irradiated with the base light L. The characteristic data detected by the detection unit 20 is consecutively input to the judgment unit 30. The judgment unit 30 compares the input characteristic data with reference data, which has been input and stored in advance in the judgment unit 30. Then, the judgment unit 30 judges whether the thickness t of the plating material 45S deposited in the pores 5 has become the same as a predetermined thickness tα.

When the reference data becomes the same as the characteristic data, the judgment unit 30 judges that the thickness t of the plating material 45S deposited in the pores 5 has become the same as the predetermined thickness tα (t=tα). Then, the judgment unit 30 outputs a coincidence judgment signal indicating the judgment result to the plating-stopping apparatus 200. When the coincidence judgment signal is input to the plating-stopping apparatus 200, the switch 56 is turned off by the plating-stopping apparatus 200.

When the switch 56 is turned off, plating is stopped. Accordingly, deposition of the plating material in the pores 5 is stopped, and plating of the member 40 to be plated is completed.

Detection of the characteristic of the reflected light in the plating-thickness monitor apparatus 100 will be specifically described.

In the plating-thickness monitor apparatus 100, the type of base light L emitted from the base light irradiation unit 10 and the kind of the characteristic of reflected light detected by the detection unit 20 may be changed in various manners. The kind of the characteristic of reflected light is the kind of the characteristic of light Le reflected from the member 40 to be plated by irradiation with the base light L, and the characteristic is an object to be detected.

As the base light L, white light Lw, monochromatic light with a known wavelength or the like may be selected. Further, plasmon scattered light, metal fluorescence, reflected light (reflected base light) of the base light or the like may be selected as light to be detected in the light Le reflected from the member 40 to be plated by irradiation with the base light L. Further, the characteristic of the reflected light maybe absorption of plasmon scattered light, metal fluorescence, an interference spectrum of reflected base light due to a phase difference caused by transmission through optical paths that are different from each other, or the like.

An absorption wavelength of plasmon scatter and the peak wavelength of metal fluorescence change based on the size of the plating material 45S deposited in the pores 5. The plating material 45S deposited in the pores 5 are very small metal particles. Specifically, the absorption wavelength of plasmon scatter and the peak wavelength of metal fluorescence change based on the thickness of plating. Further, a shift in the phase is changed when an optical path length changes by an increase in the size of the very small particle, namely by an increase in the thickness of plating. Therefore, compared with a conventional method, it is possible to more sensitively judge whether the thickness t of plating deposited in the pores 5 has become the same as the predetermined thickness tα by utilizing the absorption wavelength, the peak wavelength or the phase difference.

Light, the characteristic of reflected light and the like to be detected by the detection unit 20 may be selected from a plurality of kinds of modes. Here, a case adopting the following mode will be specifically described.

Examples 1 through 3 will be described. In Example 1, base light is white light Lw, light to be detected is plasmon scattered light Leq, a detection amount is the intensity distribution Sq of a spectrum, and the characteristic of reflected light to be detected is an absorption wavelength λq of the plasmon scattered light Leq. In Example 2, base light is monochromatic light Lm with a wavelength λm, light to be detected is metal fluorescence Lem, a detection amount is the intensity distribution Sm of a spectrum, and the characteristic of reflected light to be detected is a peak wavelength λm of the metal fluorescence Lem. In Example 3, base light is monochromatic light Lk with a wavelength λk, light to be detected is reflected light of the monochromatic light Lk, a detection amount is the intensity E of light, and the characteristic of reflected light to be detected is a phase difference of reflected base light transmitted through optical paths that are different from each other.

Plasmon scatter is described in Optics Letters, Aug. 15, 2005, Vol. 30, No. 16. Related description can be found in FIG. 2 of the document.

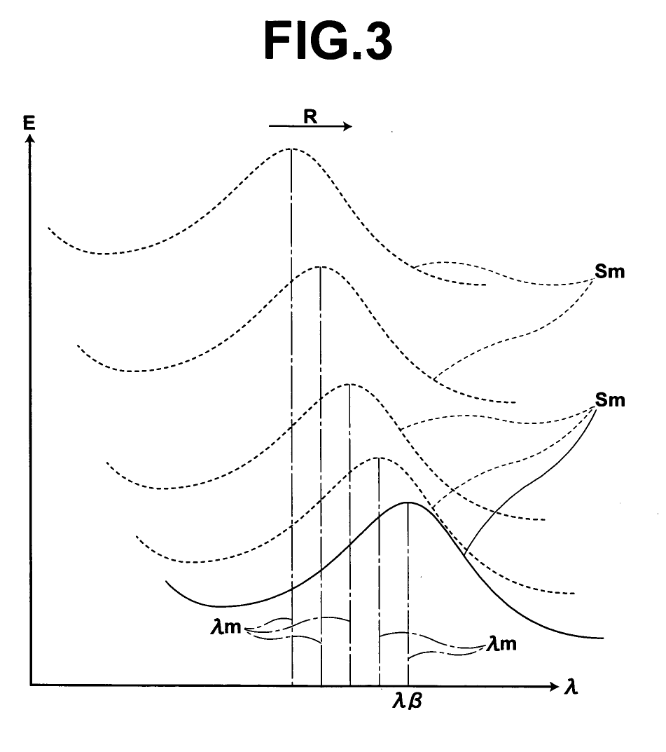

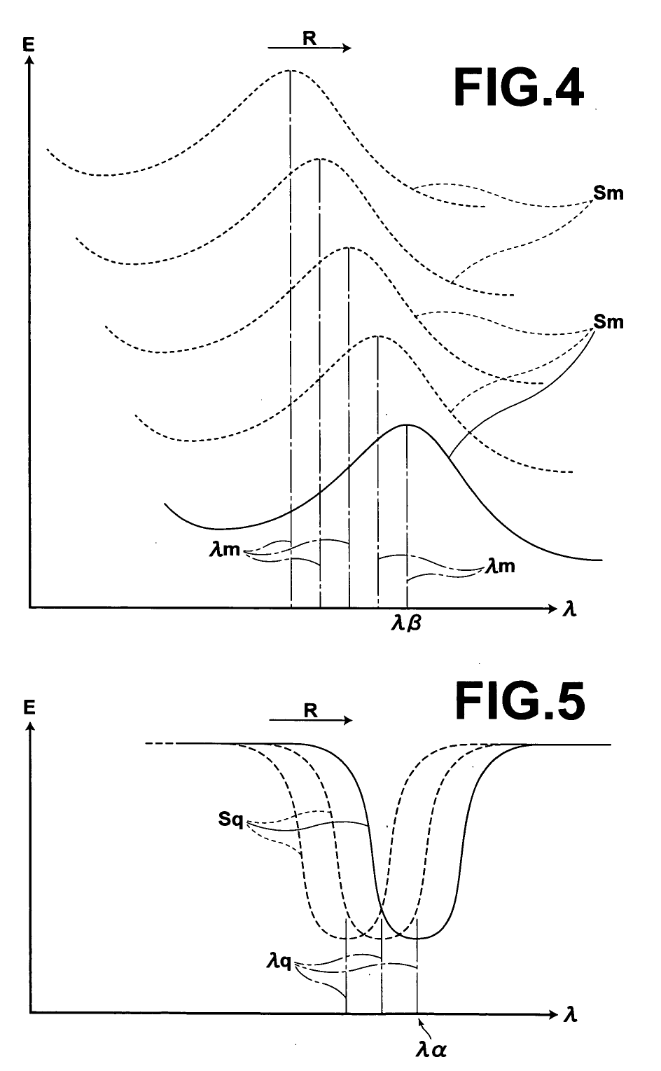

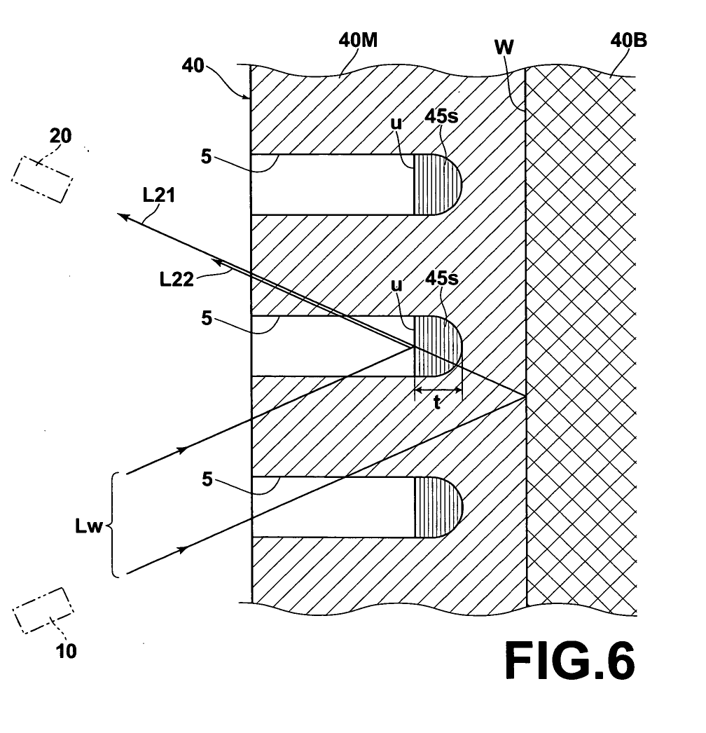

FIG. 3 is a diagram illustrating the absorption intensity distribution of spectra obtained by separating plasmon scattered light. FIG. 4 is a diagram illustrating the intensity distribution of spectra obtained by separating metal fluorescence. FIG. 5 is a diagram illustrating detection of an interference state of light reflected from the member to be plated. FIG. 6 is a diagram illustrating detection of an interference state of light reflected from the member to be plated. In each of FIGS. 3, 4 and 5, the vertical axis represents the intensity of reflected light, and the horizontal axis represents wavelengths.

### EXAMPLE 1

A case of detecting an absorption wavelength of plasmon scattered light (please refer to FIG. 3)

The switch 56 is turned on, and plating of the pores 5 on the member 40 to be plated is started.

The base light irradiation unit 10 emits white light Lw, which is base light. When the member 40 to be plated is irradiated with the white light Lw, plasmon scattered light Leq is emitted from the member 40 to be plated. The detection unit 20 consecutively obtains the intensity distribution Sm of spectra by separating the plasmon scattered light Leq. Accordingly, the detection unit 20 obtains absorption wavelengths λm, each of which is the minimum value in the intensity distribution Sm of a spectrum.

As illustrated in FIG. 3, the absorption wavelength λm, which represents the minimum value in the obtained intensity distribution Sm of each spectrum, is shifted to the long wavelength side as the thickness of plating deposited in the pores 5 increases. Specifically, the absorption wavelength λm is shifted in the right wavelength side (the direction of arrow R in FIG. 3) (hereinafter, referred to as a redshift).

The detection unit 20 consecutively outputs absorption wavelength data Dm to the judgment unit 30. The absorption wavelength data Dm is data representing an absorption wavelength λm, which is a characteristic of reflected light.

The judgment unit 30 consecutively compares the absorption wavelength λm with a base absorption wavelength λβ. The absorption wavelength λm is represented by the input absorption wavelength data Dm, and the base absorption wavelength λβ is represented by reference data which has been input and stored in advance. When the absorption wavelength λm becomes the same as the base absorption wavelength λβ, the judgment unit 30 judges that the thickness t of the plating material 45 deposited in the pores 5 has become the same as the predetermined thickness tβ. Then, the judgment unit 30 outputs a coincidence judgment signal SS representing the judgment result to the plating-stopping apparatus 200.

When the plating-stopping apparatus 200 detects the coincidence judgment signal SS, the plating-stopping apparatus 200 turns off the switch 56 and stops plating. Accordingly, plating of the member 40 to be plated is completed.

### EXAMPLE 2

A case of detecting the peak wavelength of metal fluorescence (please refer to FIG. 4)

A feature that the peak wavelength of fluorescence changes as the size of a metal nanoparticle changes is disclosed in “Brilliant Optical Properties of Nanometric Noble Metal Spheres, Rods, and Aperture Arrays”, Appl. Spectroscopy, Vol. 56, No. 5, pp. 124A-135A, 2002. This feature may be adopted to control the thickness of plating.

The switch 56 is turned on, and plating of the pores on the member 40 to be plated is started.

The base light irradiation unit 10 emits white light Lw, which is base light. When the member 40 to be plated is irradiated with the white light Lw, metal fluorescence Lem is emitted from the member 40 to be plated. The detection unit 20 consecutively obtains the intensity distribution Sm of spectra by separating the metal fluorescence Lem. Accordingly, the detection unit 20 obtains the peak wavelength Sm in the intensity distribution Sm of each spectrum.

As illustrated in FIG. 4, the peak wavelength λm in the intensity distribution Sm of each spectrum is redshifted (shifted in the direction of arrow R in FIG. 4) as the thickness of plating deposited in the pores 5 increases.

The detection unit 20 consecutively outputs peak wavelength data Dm to the judgment unit 30. The peak wavelength data Dm is data representing a peak wavelength λm, which is a characteristic of reflected light.

The judgment unit 30 compares the peak wavelength λm with a base absorption wavelength λβ. The peak wavelength λm is represented by the input peak wavelength data Dm, and the base peak wavelength λβ is represented by reference data which has been input and stored in advance. When the peak wavelength λm becomes the same as the base peak wavelength λβ, the judgment unit 30 judges that the thickness t of the plating material 45 deposited in the pores 5 has become the same as the predetermined thickness tβ. Then, the judgment unit 30 outputs a coincidence judgment signal SS representing the judgment result to the plating-stopping apparatus 200.

When the plating-stopping apparatus 200 detects the coincidence judgment signal SS, the plating-stopping apparatus 200 turns off the switch 56 and stops plating. Accordingly, plating of the member 40 to be plated is completed.

### EXAMPLE 3

A case of detecting a phase difference in interference light (please refer to FIGS. 5 and 6)

The switch 56 is turned on, and plating is started to deposit a plating material in the pores on the member 40 to be plated.

When white light Lw, which is base irradiation light, is emitted, an absorption spectrum Sq is obtained by an interference effect. The absorption spectrum Sq is obtained by a phase difference caused by interference between reflected white light L22 and reflected white light L21. The reflected white light L22 is light reflected from the surface of the plating material 45S deposited in the pores 5 by irradiation with the white light Lw. The reflected white light L21 is light reflected from the surface of the base material 40B by irradiation with the white light Lw transmitted through the anodized coating 40M. As illustrated in FIG. 5, as the thickness of the deposited plating material 45S increases, an optical path difference between the two kinds of reflected white light changes and a phase difference changes. Therefore, the absorption spectrum Sq is shifted. A phase difference Nk between the reflected white light L21 and the reflected white light L22 is detected based on a change in an interference state (phase difference) between the reflected white light L21 and the reflected white light L22. Specifically, the phase difference Nk is detected based on a change in the intensity of reflection of the reflected white light, which is a characteristic of the reflected light. Phase difference data Dk, which is characteristic data representing the phase difference Nk, is output to the judgment unit 30.

The judgment unit 30 compares the phase difference Nk represented by the input phase difference data Dk with a base phase difference Nα. The base phase difference Nα is reference data that has been input and stored in advance. When the phase difference Nk becomes the same as the base phase difference Nα, the judgment unit 30 judges that the thickness t of the plating material 45 deposited in the pores 5 has become the same as a predetermined thickness tα. Then, the judgment unit 30 outputs a coincidence judgment signal SS indicating the judgment result to the plating-stopping apparatus 200.

When the coincidence judgment signal SS is input to the plating-stopping apparatus 200, the switch 56 is turned off, and plating is stopped. Accordingly, plating of the member 40 to be plated is completed.

In the above [Example 3], a change in the absorption spectrum was detected by using white light Lw as base irradiation light. However, the base irradiation light may be monochromatic light Lm, and a change in the absorption spectrum may be estimated by measuring a change in the intensity of the monochromatic light Lm. The thickness of plating may also be monitored based on the change in the absorption spectrum.

As a method for judging the thickness of plating by detecting a phase difference, as described above, a peak-valley method may be adopted, for example. The peak-valley method is disclosed in Japanese Unexamined Patent Publication No. 9(1997)-243332.

When the thickness of plating is less than or equal to a few hundred nm, the characteristic of reflected light detected by the detection unit 20 is mainly an absorption wavelength of plasmon scattered light or the peak wavelength of metal fluorescence. However, when the thickness of plating exceeds a few hundred nm, a dominant characteristic of reflected light detected by the detection unit 20 is a phase difference between two kinds of reflected base light transmitted through optical paths that are different from each other.

Here, the thickness t of plating may be judged by detecting the characteristic of reflected light with respect to light including at least two of plasmon scattered light, metal fluorescence and reflected interference light. When the thickness t of plating is judged in such a manner, the characteristic of the reflected light is influenced by various factors, such as generation of plasmon absorption, generation of metal fluorescence and interference of reflected base light. Therefore, the characteristic of reflected light that has been detected when the thickness of the plating material 45S deposited in the pores 5 is a predetermined thickness tα is stored in the judgment unit 30 as reference data. The reflected light is light influenced by the various factors, as described above.

It is not necessary that the very small pores are formed by anodization. The very small pores may be formed by any known method.

The present invention is not limited the aforementioned embodiments. The present invention may also be achieved in the following manner.

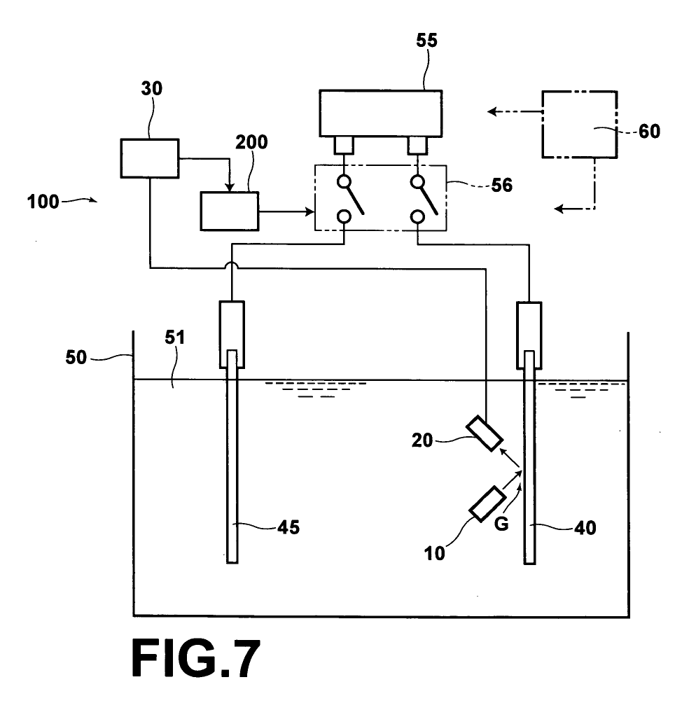

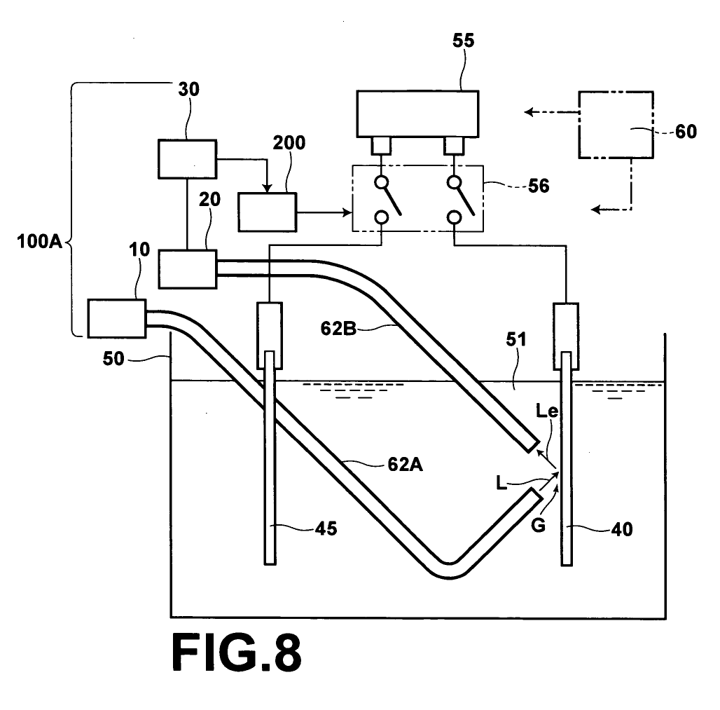

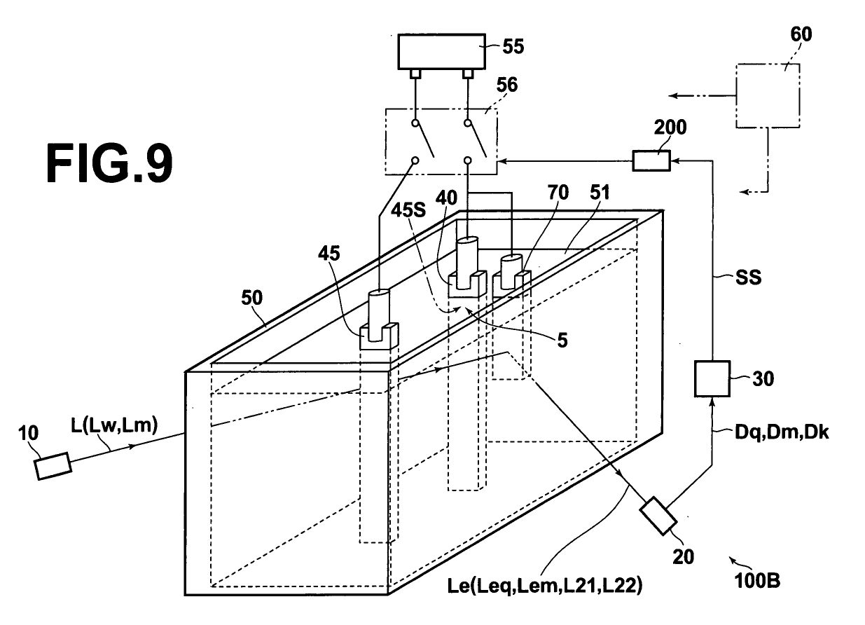

FIG. 7 is a diagram illustrating a mode in which a base light irradiation unit and a detection unit are arranged in a plating solution. FIG. 8 is a diagram illustrating a mode in which irradiation with base light and detection of light emitted from the member to be plated are performed through optical fibers. FIG. 9 is a diagram illustrating a mode in which the characteristic of reflected light is detected using a reference member similar to a member to be plated.

As illustrated in FIG. 7, the base light irradiation unit 10 and the detection unit 20 may be arranged in the plating solution 51.

Alternatively, as illustrated in FIG. 8, a plating-thickness monitor apparatus 100A may be prepared. The plating-thickness monitor apparatus 100A is a plating-thickness monitor apparatus further including an optical fiber 62A and an optical fiber 62B in addition to the elements provided in the aforementioned plating-thickness monitor apparatus. In the plating-thickness monitor apparatus 100A, base light L emitted from the base light irradiation unit 10 may be transmitted through the optical fiber 62A and the member 40 to be plated may be irradiated with the base light L. Further, light Le reflected from the member 40 to be plated by irradiation with the base light L may be transmitted through the optical fiber 62B, and the reflected light Le may be detected by the detection unit 20.

Further, it is not necessary that the plating-stopping apparatus 200 is provided. A judgment result by the plating-thickness monitor apparatus 100 may be visually checked and plating may be stopped by manually turning off the switch 56.

Further, as illustrated in FIG. 9, a reference member 70 similar to a plating member (electrode member) 45 may be soaked in the plating solution 51, in which the plating member 45 and the member 40 to be plated have been soaked. Then, the thickness of plating may be judged using the reference member 70.

Specifically, in a plating-thickness monitor apparatus 100B illustrated in FIG. 9, the reference member 70 is irradiated with base light L emitted from the base light irradiation unit 10 during plating. Further, the characteristic of light Le reflected from the reference member 70 by irradiation with the base light L is detected by the detection unit 20. Then, the judgment unit 30 judges whether the thickness of the plating material 45S deposited in the pores 5 has become the same as a predetermined thickness. Other structure and operation are similar to those of the plating-thickness monitor apparatus 100.

More specifically, the base light L may be white light Lw, and the characteristic of reflected light may be an absorption wavelength λq of plasmon scattered light Leq included in the light Le reflected from the reference member 70. Alternatively, the base light L may be monochromatic light Lm, and the characteristic of reflected light may be the peak wavelength λm of metal fluorescence Lem included in light L emitted from the reference member 70. Further, plating may be stopped by using the plating-stopping apparatus 200.

What is claimed is:

1. A plating-thickness monitor apparatus for examining the thickness of a plating material to be deposited in very small pores formed on a member to be plated when the very small pores are plated with a metal, the apparatus comprising:
a base light irradiation means for irradiating the member to be plated with base light during plating;
a detection means for detecting the characteristic of light reflected from the member to be plated by irradiation with the base light; and
a plating-thickness monitor means for examining, based on a detection result obtained by the detection means, the thickness of the plating material deposited in the very small pores.

2. A plating-thickness monitor apparatus as defined in claim 1, wherein the base light is white light, and wherein the characteristic of the reflected light is a change in the spectrum of the light reflected from the member to be plated.

3. A plating-thickness monitor apparatus as defined in claim 1, wherein the base light is monochromatic light, and wherein the characteristic of the reflected light is a change in the intensity of the light reflected from the member to be plated.

4. A plating-thickness monitor apparatus for judging the thickness of a plating material to be deposited in very small pores formed on a member to be plated when the very small pores are plated with a metal, the apparatus comprising:
a base light irradiation means for irradiating a reference member similar to the member to be plated with base light during plating;
a detection means for detecting the characteristic of light reflected from the reference member by irradiation with the base light; and
a plating-thickness monitor means for examining, based on a detection result obtained by the detection means, the thickness of the plating material deposited in the very small pores.

5. A plating-thickness monitor apparatus as defined in claim 4, wherein the base light is white light, and wherein the characteristic of the reflected light is a change in the spectrum of the light reflected from the reference member.

6. A plating-thickness monitor apparatus as defined in claim 4, wherein the base light is monochromatic light, and wherein the characteristic of the reflected light is a change in the intensity of the light reflected from the reference member.

7. A plating-thickness monitor apparatus as defined in claim 1, wherein the very small pores are formed on a surface layer deposited on the surface of a substrate forming the member to be plated, and wherein the characteristic of the reflected light is a phase difference caused by interference between light reflected from the surface of the plating material deposited in the very small pores by irradiation with the base light and light reflected from the surface of the substrate by irradiation with the base light transmitted through the surface layer.

8. A plating-thickness monitor apparatus as defined in claim 4, wherein the very small pores are formed on a surface layer deposited on the surface of a substrate forming the member to be plated, and wherein the characteristic of the reflected light is a phase difference caused by interference between light reflected from the surface of the plating material deposited in the very small pores by irradiation with the base light and light reflected from the surface of the substrate by irradiation with the base light transmitted through the surface layer.

9. A plating-thickness monitor apparatus as defined in claim 7, wherein the base light is white light.

10. A plating-thickness monitor apparatus as defined in claim 8, wherein the base light is white light.

11. A plating-thickness monitor apparatus as defined in claim 7, wherein the base light is monochromatic light.

12. A plating-thickness monitor apparatus as defined in claim 8, wherein the base light is monochromatic light.

13. A plating-thickness monitor apparatus as defined in claim 1, wherein the very small pores are formed by anodizing the member to be plated.

14. A plating-thickness monitor apparatus as defined in claim 4, wherein the very small pores are formed by anodizing the member to be plated.

15. A plating-thickness monitor apparatus as defined in claim 7, wherein the very small pores are formed by anodizing the member to be plated.

16. A plating-thickness monitor apparatus as defined in claim 8, wherein the very small pores are formed by anodizing the member to be plated.

17. A plating-stopping apparatus for a plating-thickness monitor apparatus as defined in claim 1, wherein plating is stopped when a signal indicating that the thickness of the plating material deposited in the very small pores has been judged to be the same as a predetermined thickness is detected.

18. A plating-stopping apparatus for a plating-thickness monitor apparatus as defined in claim 4, wherein plating is stopped when a signal indicating that the thickness of the plating material deposited in the very small pores has been judged to be the same as a predetermined thickness is detected.
